(19) United States
(12) Patent Application Publication
(10) Pub. No.: US 2005/0140799 A1
(43) Pub. Date: Jun. 30, 2005

(54) Memory access control unit and network camera apparatus

(75) Inventor: Shinichi Murakami, Oonojyou-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/018,318

(22) Filed: Dec. 22, 2004

(30) Foreign Application Priority Data
Dec. 25, 2003 (JP) 2003-429467

(51) Int. Cl. H04N 5/76

(52) U.S. Cl. 348/231.99

(57) ABSTRACT

A bus dedicated to a memory separate from a CPU bus is provided between an image compression unit and a memory access control unit. In case an access request from the CPU and an access request from the image compression unit have occurred with the same timing, the access from the image compression unit to the memory is given permission on a on a first priority basis. In this configuration, the image compression unit and the memory are interconnected via a dedicated data bus separate from a CPU bus. This makes it possible for the image compression unit to access the memory without affecting the CPU operation thus keeping the system performance. The invention has a sequential access determination feature and a bus sizing feature to reduce the number of access cycles. A refresh timing on the memory is generated using a signal input from outside, which reduces the unit scale.

### BACKGROUND OF THE INVENTION

The present invention relates to a memory access control unit as well as a network camera apparatus capable of transmitting an image picked up by the camera apparatus to the outside via a network.

In the related art, a unit connected to a CPU accesses a memory via the CPU connected to the same bus as the memory. While the unit is accessing the memory, the CPU cannot perform other operations because the bus is occupied by the memory access operation. This could lower the system performance (for example, refer to the Japanese Patent Laid-Open No. 62-92586/(1987)).

As mentioned above, a CPU or another unit accesses a memory via the CPU. Thus, while another unit is accessing a memory, the CPU cannot perform other operations, which will lower the system performance.

### SUMMARY OF THE INVENTION

The invention solves the problems and has as an object to provide a memory access control unit which prevents the CPU from lowering its performance while another unit is accessing a memory.

A memory access control unit according to the invention is connected to a CPU via a first bus, image compression unit via a second bus, and a memory via a third bus, and accepts an access request from a unit (CPU or image compression unit) accessing the memory and performs memory access control.

According to the invention, the image compression unit and the memory are interconnected via a dedicated data bus separate from a CPU bus. This makes it possible to access the memory without affecting the CPU operation thus keeping the system performance.

The invention has a sequential access determination feature and a bus sizing feature. The configuration reduces the memory access cycle and generates a refresh timing to the memory by using a signal input from the outside. This eliminates the need for an additional refresh timing generation unit, thus reducing the unit scale.

A first aspect of the invention to solve the problems is a memory access control unit connected to a CPU via a first bus, an image compression unit via a second bus, and a memory via a third bus, in that the memory access control unit has a feature to accept an access request from a unit (CPU or image compression unit) accessing a memory and performs memory access control (access permission and instruction for waiting) and, in case an access request from the CPU and one From the image compression unit has taken place with the same timing, permits the memory access request made by the image compression unit on a first priority basis.

In this configuration, the image compression unit and the memory are interconnected via a dedicated data bus separate from a CPU bus. This makes it possible for the image compression unit to access the memory without affecting the CPU operation thus keeping the system performance. Even in case the data carried in the access from the image compression unit to the memory is huge, it is possible to perform arbitration to permit a memory access on a first priority basis, thereby smoothly allowing the memory access from the image compression unit to the memory.

According to second aspect of the invention, it is enabled an access from the CPU to the memory with the width of the CPU data bus adjusted particularly in case the width of the CPU data bus is different from that of the memory data bus. This provides flexible support even when the bus widths are different from each other.

According to third aspect of the invention, the address used in the last access is compared with that used in the current access, and the number of access cycles is reduced in case the addresses have matched each other. This prevents an increase in the access cycle and reduces the processing time.

According to fourth aspect of the invention, a timing of externally executing a refresh operation is generated in synchronization with a signal input in case the memory is an SDRAM. This eliminates the need for providing a new refresh timing generation unit, thereby reducing the unit scale.

### BRIEF DESCRIPTION OF THE DRAWINGS

FIG. 1 is a block diagram of a memory access control unit and a peripheral unit according to the invention;

FIG. 2 is an internal block diagram of the memory access control unit according to the invention;

FIG. 3 is a flowchart showing the operation of an arbitration unit according to the invention;

FIG. 4 is a flowchart showing the operation of the arbitration unit according to the invention;

FIG. 5 is an explanatory drawing of a sequential access determination feature according to the invention;

FIG. 6 is a flowchart showing the sequential access determination feature according to the invention;

FIG. 7 an explanatory drawing of as a bus sizing feature according to the invention; and

FIG. 8 is an explanatory drawing of refresh timing generation according to the invention.

### DETAILED DESCRIPTION OF THE PREFERRED EMBODIMENTS

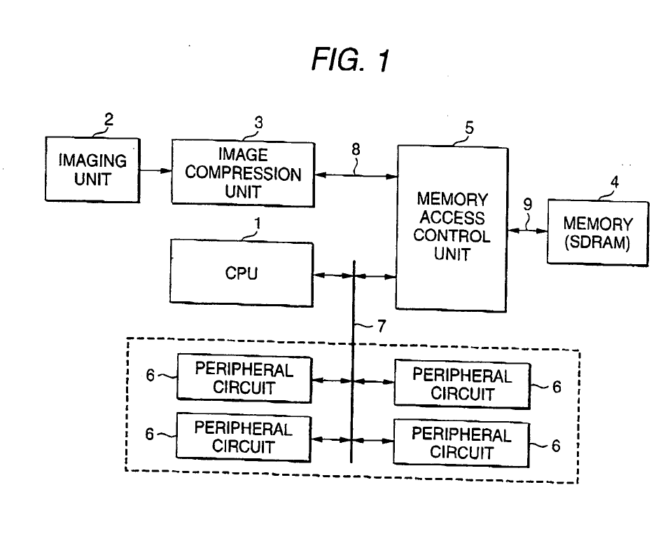

Embodiments 1 through 5 are described below referring to FIGS. 1 a through 8.

### Embodiment 1

FIG. 1 shows a network camera apparatus equipped with a memory access control unit according to an embodiment of the invention.

In FIG. 1, a numeral 1 represents a CPU for controlling the operation of the network camera apparatus, 2 an imaging unit including an image pickup device and optics for photographing a moving picture or a still picture, and 3 an image compression unit for compressing the image data of a still picture photographed by the image compression unit 2 as well as instructing the compressed image data to be transferred to a memory.

A numeral 4 represents a memory used by the CPU 1 to issue an instruction or temporarily storing data as well as temporarily storing image data before and after compression, and 5 a memory access control unit for controlling an access to the memory 5 (permission of an access to the memory or instruction of placing the access in wait state to an access requester). Also included are a plurality of peripherals which are connected to the CPU 1 and which directly receives an instruction therefrom to perform a variety of features as a network camera apparatus. In the following description, the peripherals are generally called a peripheral group 6.

A numeral 7 represents a CPU bus (first bus) comprising address/data/control signals in order to connect the CPU 1 with the memory access control unit 5 and the peripheral group 6. A numeral 8 represents a bus dedicated to an image (second bus) comprising address/data/control signals in order to connect the image compression unit 3 with the memory access control unit 5. A numeral 9 represents a memory bus (third bus) comprising address/data/control signals in order to connect the memory 4 with the memory access control unit 5.

Operation of the invention will be described referring to FIG. 1. In case an access is made from the CPU 1 to the memory 4, the CPU 1 issues an access request to the memory access control unit 5 via the CPU bus 7. Unless the other access request, that is, an access request from the image compression unit 3 is not present, the memory access control unit 5 determines that the access from the CPU 1 should be allowed and permits the access from the CPU 1 and starts an access to the memory 4.

In case an access is made from the image compression unit 3 to the memory 4, the image compression unit 3 issues an access request to the memory access control unit 5. In case an access request from the CPU 1 is not present, the memory access control unit 5 determines that the access from the image compression unit 3 should be allowed and permits the access from the image compression unit 3 and starts an access to the memory 4.

This invention provides the bus dedicated to an image 8 for accessing the memory 4 from the image compression unit 3, apart from the CPU bus 7. An access from the image compression unit 3 to the memory 4 is made without the intervention of the CPU 1, so that the CPU 1 is operable while an access is made from the image compression unit 3 to the memory 4. An access from the CPU 1 to the peripheral group 6 is not affected even when a large number of accesses are made from the image compression unit to the memory 4. This ensures that the performance of the CPU 1 not lowered.

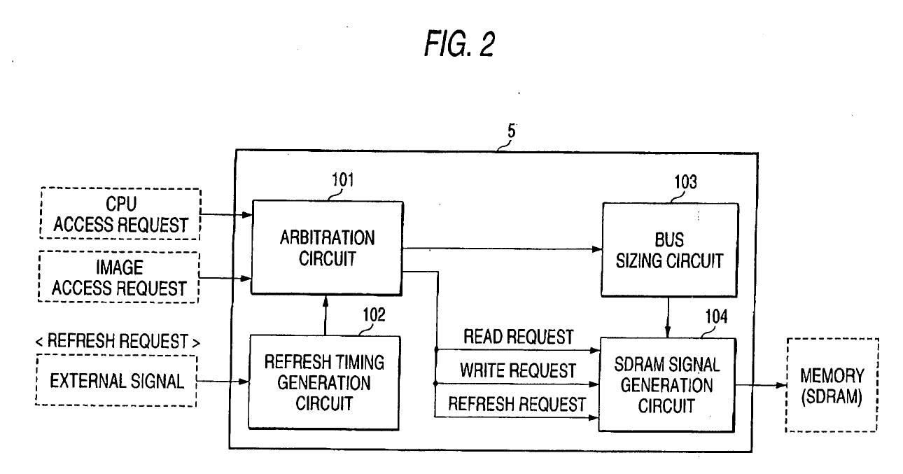

Configuration and operation of an internal block of the memory access control unit 5 in Embodiment 1 are described below referring to FIG. 2.

In FIG. 2, a numeral 101 represents an arbitration unit for arbitrating access requests and refresh requests from a plurality of locations to the memory 4 and issuing a command instruction to the memory 4. A numeral 102 represents a refresh request generation unit for generating a timing (cycle) to execute refresh operation of the memory 4 in synchronization with an external signal. A numeral 103 represents a bus sizing unit for performing a memory access while adjusting the data bus width of an access requester to that of the memory 4. In this embodiment, the data bus width of the access requester (CPU 1 or image compression unit 3 in FIG. 1) is either 32 bits, 16 bits or 8 bits, while the data bus width of memory 4 is 16 bits. Thus, the bus sizing unit 103 converts the data from the access requester so that it will be consistent with the data bus width of the memory before performing a memory access.

A numeral 104 represents a signal gene a ion unit for generating a signal to the memory 4 in accordance with an operation instruction (read/write/refresh) to the memory set by the arbitration unit 104. For data read from the memory 4, the signal generation unit 104 outputs a signal to the memory 4 in accordance with a read instruction issued from the arbitration unit 101 and data is read from the memory 4. For data write to the memory 4, the signal generation unit 104 outputs a signal to the memory 4 in accordance with a write instruction issued from the arbitration unit 101 and data is written into the memory 4.

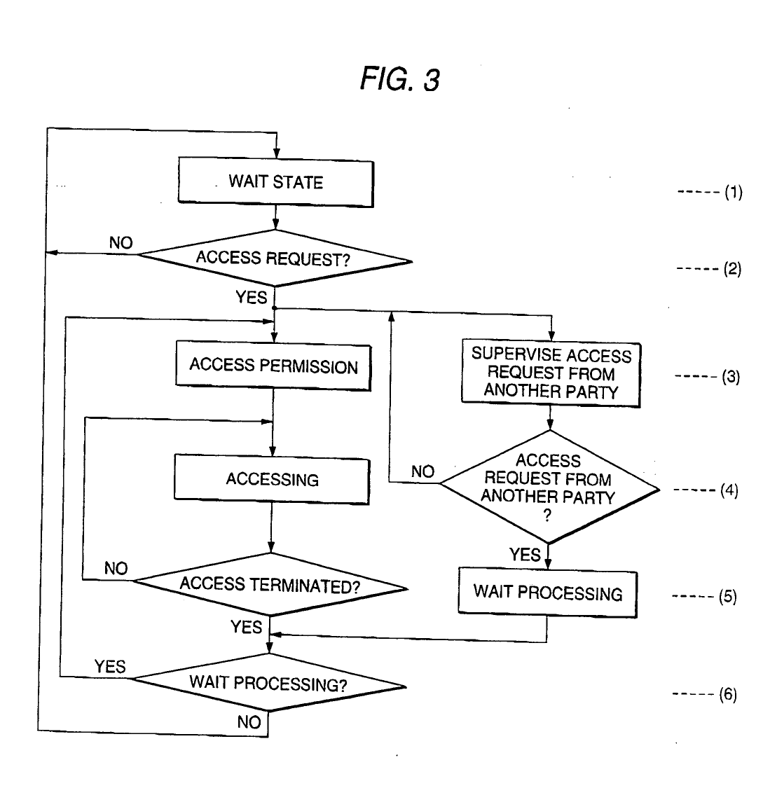

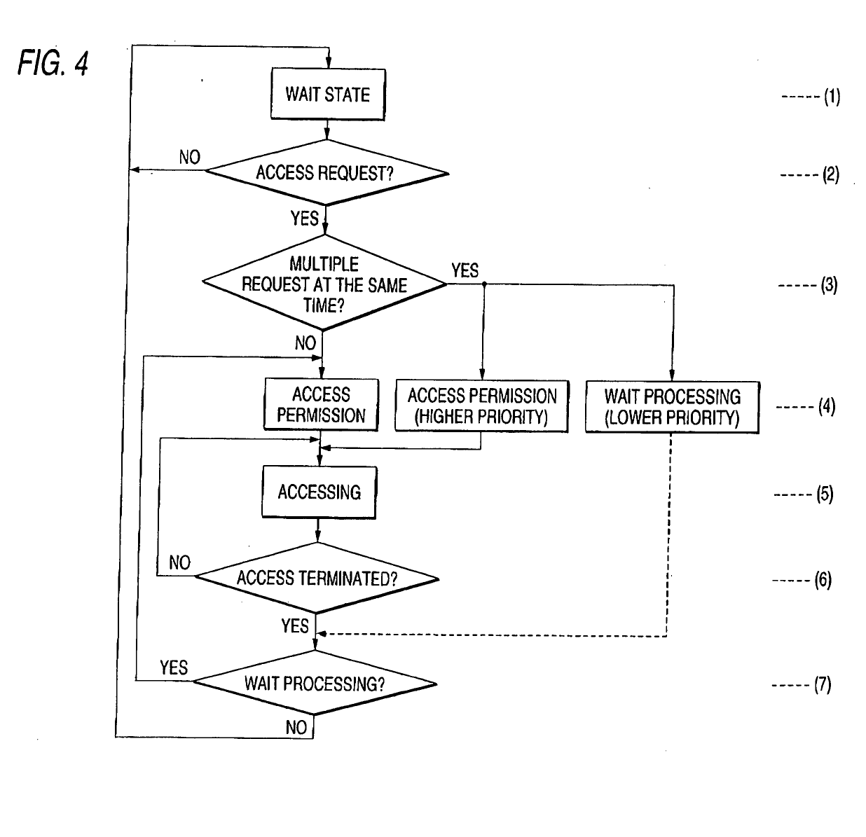

Specific flows for arbitration of operation request will be described referring to the flowchart of FIGS. 3 and 4, for a case where an access request is made by the CPU 1 or the image compression unit 3 and a case where a refresh request to the memory 4 is issued.

FIG. 3 shows a case where, while either the CPU 1 or the image compression unit 3 is accessing the memory 4, an access request is issued by the other party.

In steps (1) and (2), the access request to the memory 4 is placed in wait state. When an access request is issued, execution proceeds to step (3), access permission is given to the access requester (the CPU 1 or the image compression unit 3) and an access request issued by the other party is supervised. For example, in the presence of an access request issued by the image compression unit 3, access permission is given to the image compression unit 3 and the access request issued by the other party or CPU 1 is supervised. In steps (4) and (5), processing is made in accordance with the access request issued by the access requester (image compression unit 3). In case an access request is not issued by the other party during steps (3) through (5), execution returns to step (1) via step (6) when the access is complete.

In case an access request is issued by the other party (for example CPU 1) during steps (3) through (5), a wait signal is output to the access requester and wait processing is made. When the access requester currently making an access to the memory 4 (for example image compression unit 3) has terminated the access, access permission is given to the other access requester (execution returns to step (3)). Thereafter, processing is made in accordance with the access requester (CPU 1) in steps (4) and (5). In steps (3) through (5), an access request issued by the other party is supervised. Execution returns to step (1) via step (6) when the access is complete.

FIG. 4 shows a case where the CPU 1 and the image compression unit 3 have issued access request at the same time. In steps (1) and (2), the access request to the memory 4 is placed in wait state. In step (3), it is determined whether concurrent access requests have taken place. In case concurrent access requests are not present, the access request is given permission and steps (4) through (7) are followed. When the access is complete, execution returns to step (1).

In case concurrent access requests are issued by the CPU 1 and the image compression unit 3, access permission is given to an access requester with a higher priority. A wait signal is output to an access requester with a lower priority for wait processing (step (4)). The higher priority is given to a party which has more frequently accessed the memory 4. Setting of the priorities can be changed by way of unit change on the arbitration unit 101.

An access requester with a higher priority (for example the image compression unit 3) is given access permission, while an access requester with a lower priority (for example the CPU 1) receives a wait signal and undergoes wait processing and placed in wait state until the access requester with a higher priority completes the access to the memory 4 (steps (5) through (7)). Then access permission is given (step (4)) and the access to the memory 4 starts (steps (5) through (7)). With the memory access control unit thus configured and operating, it is possible to smoothly handling accesses to the memory 4 by way of arbitration, even in case access requests from a plurality of locations have taken place.

In an access from the image compression unit 3 to the memory 4, the data amount of a single image frame is divided and transfer of a predetermined data amount occurs without interruption. For example, while the data of a horizontal main scan line is transferred among the entire image frame data, an access request issued by the image compression unit 3 is processed without interruption. Each time data of a single line is transferred, the access request is suspended.

In case an image is photographed by the imaging unit 2 in a high precision mode (for example in the VGA size), the transfer amount of image data from the image compression unit 3 to the memory 4 naturally increases, which will increase the number of accesses to the memory 4. In case the entire data of a single image frame is transferred without interruption, it is troublesome to handle an access request issued by the CPU 1. Thus, an access request is suspended each time a predetermined amount of data is transferred.

In case a huge data access request is issued from the image compression unit 3 to the memory 4, the arbitration circuit 101, data of a single line in an image frame is transferred without interruption. Even in case a request is coming from the CPU 1 in the meantime, the access request issued by the image compression unit 3 is permitted. An access request is suspended each time a predetermined amount of data is transferred. An access from the CPU 1 is permitted while the access request is suspended.

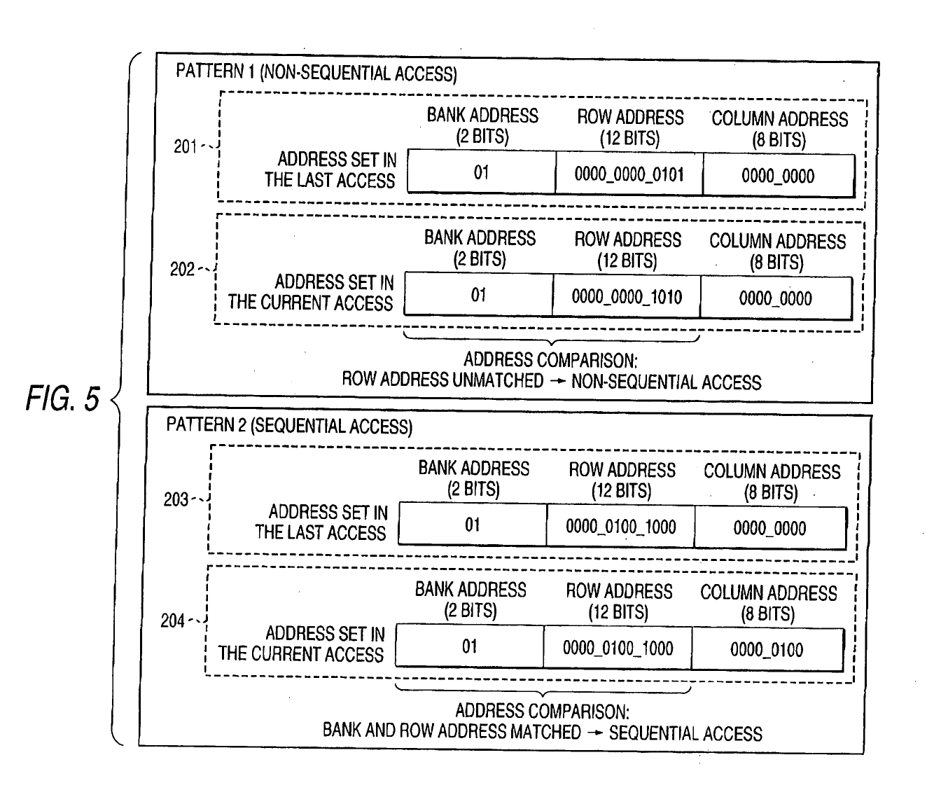

The sequential access determination feature of the memory access control unit 5 is described below referring to FIG. 5.

An access to the memory 4 (SDRAM) requires setting of addresses. The addresses are classified into a bank address, row address, and a column address. Setting of addresses is generally made in two steps in most types of memory:
(1) Bank address+Row address
(2) Bank address+Column address

The sequential access determination feature is described below. A sequential access is determined in case the bank address and row address set in the current access have matched the bank address and row address set in the last access. When a sequential access is determined, setting of address to the memory 4 in the current access requires setting of a column address alone, without a bank address or a row address, for a current access. While addresses are set in two steps in a first access to the memory, a memory access is permitted by setting a single address once a sequential access is determined. This reduces the number of cycles for address setting and thus reduces the number of access cycles to the memory 4.

The sequential access determination feature is detailed below referring to FIG. 5. A numeral 201 in Patten 1 represents addresses set in the last access and 202 addresses set in the current access. Bank addresses are common between 201 and 202 although row addresses are different. Thus a sequential access is not determined.

In Pattern 2, 203 represents addresses set in the last access and 202 addresses set in the current access. Both bank addresses and row addresses match between 203 and 204, so that a sequential access is determined. In this case, an access is permitted anew only by setting a column address, which reduces the number of access cycles.

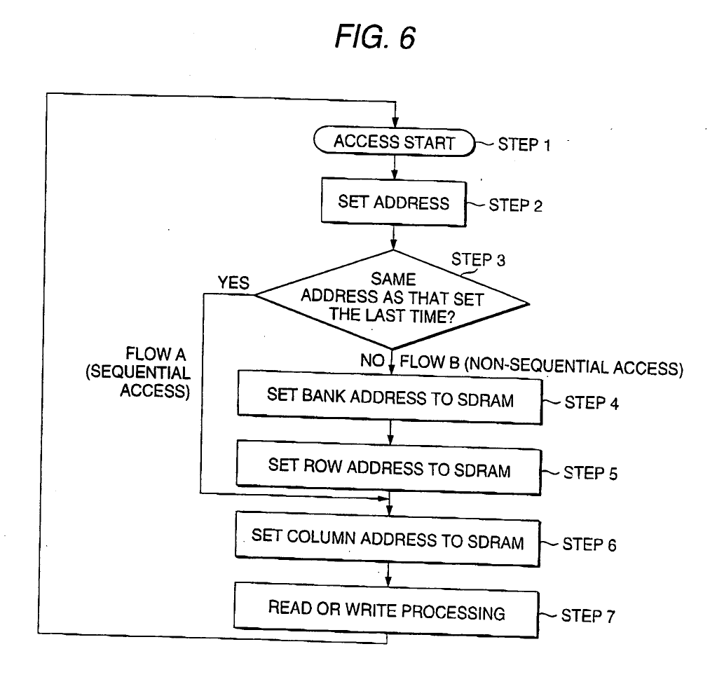

Further, operation of the sequential access determination feature is detailed referring to the flowchart of FIG. 6. In step 1, an access to the memory 4 starts. In step 2, addresses including a bank address, a row address and a column address are set. In step 3, the back addresses and row address set last time are compared with those set this time. In case they are identical, a sequential access of Flow A is determined. Otherwise, a non-sequential access of Flow B is determined.

In the case of Flow B, a back address is set in step 4, a row address is set in step 5, and a column address is set in step 6, followed by data read/write in step 7. For data read, the signal generation unit 104 outputs a signal to the memory 4 in accordance with a read instruction issued from the arbitration unit 101 and data is read from the memory 4. For data write to the memory 4, the signal generation unit 104 outputs a signal to the memory 4 in accordance with a write instruction issued from the arbitration unit 101 and data is written into the memory 4.

In the case of Flow A, it is not necessary to set a bank address and a row address to the memory 4 in steps 4 and 5. In step 6, a column address is set and data read/write is made in step 7. To be more precise, a single step of address setting allows a memory address in the case of a sequential access of Flow A, which omits the address setting steps 4 and 5, unlike the non-sequential access of Flow B. This reduces the number of access cycles.

With the foregoing configuration and features, it is possible to determine a sequential/non-sequential access by comparing a set address with one set last time, and reduce the number of access cycles for a sequential access.

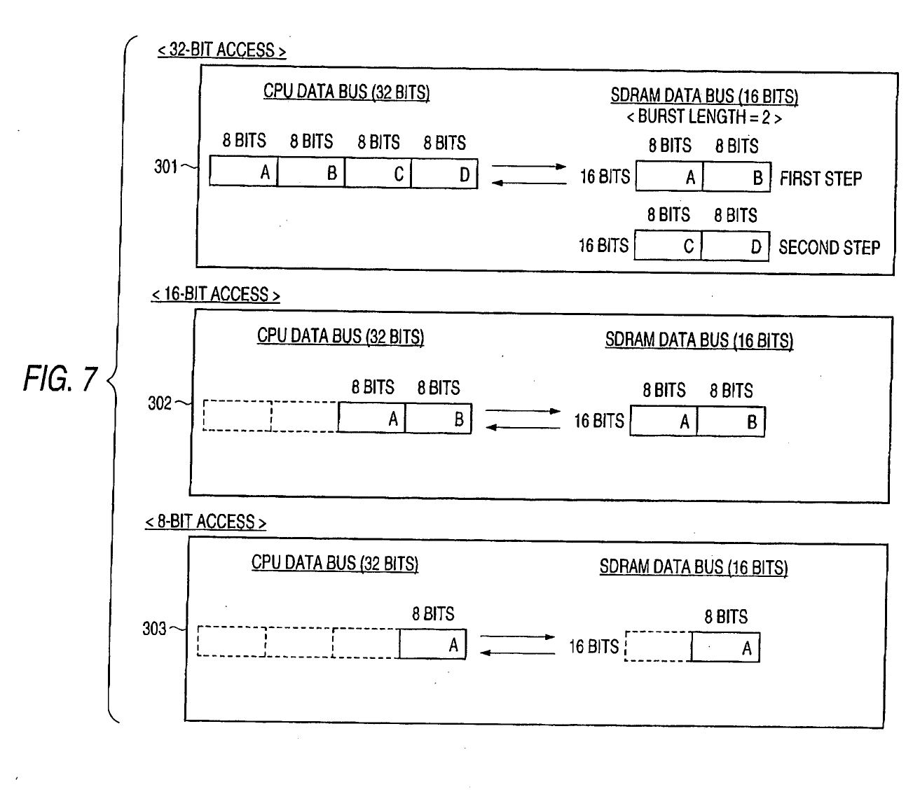

Next, the bus sizing feature of the memory access control unit 5 is described below referring to FIG. 7.

While the data bus width used in an access from the CPU 1 is generally either 8 bits, 16 bits or 32 bits, the data bus width of the memory 4 (SDRAM) may 16 bits or 8 bits, which is less than 32 bits. An 8-bit access or a 16-bit access from the CPU is performed without a problem, although a 32-bit access to the memory 4 requires adjustment of the bus width.

Specific operation of the bus sizing feature according to the invention is described using FIG. 7. During an access from the CPU 1 to the memory 4, a control signal indicating the bus width information is output from the CPU 1 and the memory access control unit 5 determines whether the bus width of the access from the CPU 1 is either 8 bits, 16 bits, or 32 bits, based on the control signal. In case the bus width is determined as 32 bits (for example, an access from the CPU 1), the data bus of the memory 4 is 16 bits, so that a 16-bit access is performed twice to support this case.

Assuming that the 10 access cycles are required to make a single access, performing a 16-bit access twice results in 20 cycles, double the ordinary number of access cycles. This naturally results in an increase in the number of access cycles In this example, a burst access (transfer of multiple bytes) is used to suppress the number of access cycles.

In the case of a 32-bit access, an access is made by dividing the 32-bit data into two burst access data (16 bits by 2 burst accesses) as shown in 301, by changing the burst length setting of the memory 4 (burst length=2) and performing a burst access (transfer of multiple bytes) The resulting number of access cycles is 11 (=10+1) and the access cycle is shortened thus the processing time is reduced.

In case the bus width is 8 bits or 16 bits (image compression unit 3), the bus width is equal to or smaller than the data bus width of the memory 4, which allows an access.

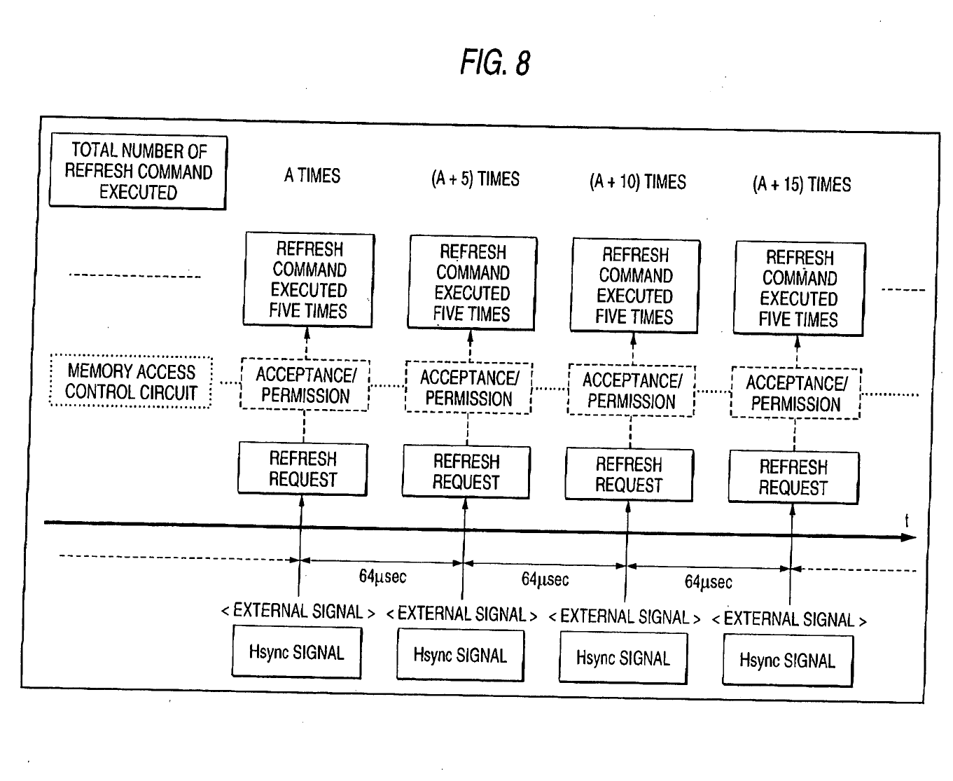

The refresh timing generation unit of the memory access control unit 5 shown in Embodiment 1 is described below referring to FIG. 8.

The refresh conditions for the memory 4 (SDRAM) are described in advance. The conditions differ between the types of memory (SDRAM). In this example, refresh conditions are used where at least 4096 refresh commands must be executed within a time period 64 msec.

In order to satisfy the conditions, a refresh timing generation unit is required. Timing generation is made by using a signal transmitted from the imaging unit 2 via an image compression unit (hereinafter referred to as the Hsync signal) As shown in FIG. 8, the Hsync signal is input every 64 microseconds. Each time the Hsync signal is input, a refresh request is issued to the memory access control unit 5. The arbitration unit 101 in the memory access control unit 5 permits refresh operation and a refresh command is executed on the memory 4. By executing five refresh commands per single input of the Hsync signal, the Hsync signal is input 100 times in the period of 64 msec. As a result, the refresh command is executed 5000 times in total in the period of 64 msec. This satisfies the refresh execution conditions on the memory 4.

While the Hsync signal is transmitted from the imaging unit 2, the Hsync signal is output with a timing an image is photographed by the imaging unit 2. When image photographing is over, the data of the photographed image started to be captured and data write to the memory 4 starts. During the time period when the image is photographed, that is, from when the Hsync signal is input to an arbitrary point in time, a access to the memory 4 for temporary storage of data does not take place.

According to this embodiment, the Hsync signal is used to generate a refresh command execution timing. This reduces the number of accesses from the image compression unit to the memory 4 with the timing the Hsync signal is input. Thus, the number of contentions or arbitrations with a refresh operation on the memory 4 will be reduced.

In this way, by generating a refresh command in synchronization with an external signal periodically input, such as the Hsync signal, and executing the refresh command, refresh operation on the memory 4 is allowed. Moreover, an internal unit to generate a refresh command timing is not required, which reduces the unit scale.

The invention is useful as a memory access control unit, in particular an imaging unit, which allows an access to a system without affecting the CPU operation thus keeping the system performance.

This application is based upon and claims the benefit of priority of Japanese Patent Application No. 2003-429467 filed on Dec. 25, 2004, the contents of which are incorporated herein by reference in its entirety.

1. A memory access control unit connected to a CPU via a first bus, an image compression unit via a second bus, and a memory via a third bus,
said memory access control unit accepting an access request from said CPU or image compression unit accessing a memory and performs memory access control and, in case an access request from the CPU and an access request from the image compression unit has taken place with the same timing, permits the memory access request made by the image compression unit to said memory on a first priority basis.

2. The memory access control unit according to claim 1, wherein said image compression unit compresses an image photographed by an imaging unit and that said memory temporarily stores the data of the image photographed by said imaging unit and the image data compressed by said image compression unit.

3. The memory access control unit according to claim 1, wherein, in case while either said CPU or image compression unit is accessing said memory, an access request is issued by the other party, the memory access control unit outputs a wait signal to the second access requester thus placing the access in wait state.

4. The memory access control unit according to claim 1, wherein, in case the width of the CPU data bus differs from that of the memory data bus, the width of the CPU data bus is adjusted to enable an access from said CPU to the memory.

5. The memory access control unit according to claim 4, wherein, in case the data bus of said CPU is wider than that of said memory, the memory access control unit performs bust access control processing from said CPU.

6. The memory access control unit according to claim 1, wherein the address used in the last access is compared with that used in the current access, and reduction of the number of access cycles is allowed in case the addresses have matched each other.

7. The memory access control unit according to claim 6, wherein the memory access control unit sets a combination of a bank address and a row address in one step and a combination of a bank address and a column address in another step when accessing said memory and,
in case the combination of a bank address and a row address set in an access matches the combination of the bank address and the row address set in the last access (sequential access: Flow A), sets only a column address to the memory, not a bank address or a row address, before performing data read/write and
in case the combination of the bank address and the row address set in an access dos not match the combination of the bank address and the row address set in the last access (non-sequential access: Flow B), sets a bank address, a row address then a column address to the memory, before performing data read/write.

8. The memory access control unit according to claim 1, wherein a timing of externally executing a refresh operation is generated in synchronization with a signal input in case the memory is an SDRAM.

9. A memory access control unit connected to a CPU via a first bus, an image compression unit via a second bus, and a memory via a third bus,
said memory access control unit accepting an access request from said CPU or image compression unit accessing a memory and performs memory access control and, in case an access request from the CPU and one from the image compression unit has taken place with the same timing, permitting the memory access request made by the image compression unit to said memory on a first priority basis, and in case an access request is issued from the CPU while said image compression unit is accessing said memory, outputting a wait signal to the CPU, and stops outputting the wait signal to the CPU only when the processing on the access request issued from the CPU is suspended.

10. A network camera apparatus capable of transmitting a photographed image from outside via a network, comprising:
a CPU for controlling the operation of the network camera apparatus;
an imaging unit to photographing an image;
an image compression unit for compressing the data of an image photographed by said imaging unit;
a memory used by said CPU to temporarily store data or temporarily store image data received from said imaging unit;
a peripheral group connected to said CPU, said peripheral group performing a variety of features as a network camera apparatus; and a memory access control unit for controlling an access to said memory;
wherein said network camera apparatus connects said CPU, said memory access control unit and said peripheral group via a first bus,
said image compression unit and said memory access control unit via a second bus, and
said memory and said memory access control unit via a third bus, and that
said memory access control unit accepts an access request from said CPU or image compression unit and, in case an access request from the CPU and one from the image compression unit has taken place with the same timing, permits the memory access request made by the image compression unit to said memory on a first priority basis.

11. A control method for accepting an access request from a CPU or an image compression unit to perform memory access control, wherein
in case an access request from the CPU has taken place while said image compression unit is accessing the memory, said method permits the memory access request made by the image compression unit to the memory on a first priority basis,
outputs a wait signal to the CPU while the access request from the image compression unit is being processed, and
stops outputting the wait signal to the CPU only when the processing on the access request issued from the CPU is suspended.
